(19) United States
(12) Patent Application Publication
(10) Pub. No.: US 2003/0196646 A1
(43) Pub. Date: Oct. 23, 2003

(54) Exhaust gas recirculation system for engine incorporating turbo-supercharger

(76) Inventors: Koji Shoyama, Tokyo (JP); Tetsuya Okazaki, Tokyo (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/456,002

(22) Filed: Jun. 6, 2003

Related U.S. Application Data
(62) Division of application No. 09/677,112, filed on Sep. 29, 2000.

(30) Foreign Application Priority Data
Oct. 6, 1999 (JP) HEI 11-285404

(51) Int. Cl. F02M 25/07

(52) U.S. Cl. 123/568.14; 123/568.21; 123/90.16; 60/605.2

(57) ABSTRACT

An EGR valve for adjusting the flow rate of exhaust gas recirculated into an intake passage connected to an intake port of a cylinder in an engine and adapted to feed air therethrough into the cylinder through the intermediary of a compressor housing of a turbo-supercharger, is incorporated in an EGR passage connecting the intake passage with an exhaust passage connected to an exhaust port of the cylinder and adapted to discharge exhaust gas from the cylinder into the atmosphere through the intermediary of a turbine housing of the turbo-supercharger, that is, the above-mentioned EGR valve and EGR passage constitute an external EGR device. Further, the engine is provided with an internal EGR device for opening an exhaust valve so as to introduce exhaust gas from the exhaust passage into the cylinder during intake stroke of the cylinder. The EGR valve is controlled by a controller in accordance with detection outputs from a speed sensor and a load sensor. With this arrangement, the emission of NOx in exhaust gas can be reduced by recirculating exhaust gas into the cylinder over the entire engine operation range without boosting up the pressure of EGR gas.

### BACKGROUND OF THE INVENTION

1. Field of the Invention

The present invention relates to an exhaust gas recirculation system (EGR) for returning a part of exhaust gas into an intake passage or a cylinder of an engine having a turbo-supercharger.

2. Background Art

Heretofore, there has been known an exhaust gas recirculation system, as mentioned above, having such an arrangement that a cylinder in an engine is connected at its intake port with an intake pipe for supplying air into the cylinder through the intermediary of a compressor of a turbo-supercharger, and is connected at its exhaust port with an exhaust pipe for discharging exhaust gas into the atmosphere from the cylinder through the intermediary of a turbine of the turbo-supercharger, and an EGR pipe branching from an exhaust manifold and connected to an intake manifold is provided thereto with an EGR valve which is controlled by a controller in accordance with a speed and a load of the engine.

In the exhaust gas recirculation system having the above-mentioned arrangement, the controller causes the EGR valve to open in an engine operation range from a low load to a middle load so as to recirculate a part of exhaust gas into the intake system in order to lower the maximum combustion temperature of a mixture within the cylinder, resulting in reduction of NOx, due to a thermal capacity owned by the exhaust gas (inert gas) or due to an decrease in the oxygen density in intake air while the controller causes the EGR valve to close in an engine operation range from a middle load to a high load so as to stop the recirculation of the exhaust gas in order to eliminate insufficiency of air in the cylinder, resulting in reduction of emission of black smoke from the engine.

However, in the above-mentioned exhaust gas recirculation system, since the EGR valve is completely closed in the operation range from a middle load to a high load of the engine, there has be caused such a disadvantage that the maximum combustion temperature of a mixture in the cylinder rises up in the cylinder so as to increase the NOx. Further, even though the EGR valve is opened in the engine operation range from a middle load to a high load, the flow rate of exhaust gas from the engine is increased so that the turbo-supercharger is rotated at a higher speed, and accordingly, no substantial difference is appreciated between the intake air pressure in the intake manifold and the exhaust gas pressure in the exhaust manifold. Thus, there has been raised such a problem that exhaust gas cannot be recirculated into the intake manifold.

In order to eliminate the above-mentioned problem, it has been considered such methods that variable static vanes are rotated in a direction in which the turbo-pressure is decreased in the case of using a variable static vane type turbo-supercharger, while a turbo-supercharger is miniaturized in the case of using a fixed static vane type turbo-supercharger. According to the above-mentioned methods, the EGR gas can be smoothly recirculated into the intake manifold even in the operation range from a middle load to a high load.

However, there would be raised a problem of deteriorating the strength of an engine even with thus improved exhaust gas recirculation systems since the pressure of EGR gas is effected in the cylinder in addition to the pressure of intake air increased by the turbo-supercharger, and further, the temperature in the cylinder is raised due to these pressures.

### SUMMARY OF THE INVENTION

An object of the present invention is to provide an exhaust gas recirculation system for an engine incorporating a turbo-supercharger, which can reduce NOx in exhaust gas by recirculating a part of exhaust gas into a cylinder in an entire engine operation range including not only a low-to-middle load engine operation range but also a middle-to-high load engine operation range, without increasing the pressure of EGR gas and reinforcing the engine.

To the end, according to a first aspect of the present invention, there is provided an exhaust gas recirculation system for an engine incorporating a turbo-supercharger, comprising an intake passage connected to an intake port of an engine, for supplying air into a cylinder of the engine through the intermediary of a compressor housing of a turbo-supercharger, an exhaust passage connected to an exhaust port of the engine, for discharging exhaust gas into the atmosphere from the cylinder through the intermediary of a turbine housing of the turbo-supercharger, an external EGR device including an EGR passage connected at one end thereof to the exhaust passage and at the other end thereof to the intake passage, an EGR valve provided in the EGR passage, for regulating the flow rate of exhaust gas recirculated from the exhaust passage into the intake-air passage through the EGR passage, an internal EGR device for opening exhaust valves provided at the exhaust port so as to introduce exhaust gas from the exhaust passage into the cylinder during intake stroke of the cylinder, a speed sensor for detecting a speed of the engine, a load sensor for detecting a load of the engine, and a controller for controlling the EGR valve or both EGR valve and internal EGR device in accordance with detection outputs from the speed sensor and the load sensor.

In the exhaust gas recirculation system according to the first aspect of the present invention, the controller opens the EGR valve in accordance with detection outputs from the speed sensor and the load sensor in the engine operation range from a low load to a middle load. Exhaust gas is recirculated from the exhausts passage into the cylinder through the EGR valve by means of the external EGR device, and exhaust gas also flows into the cylinder, direct from the exhaust port by means of the internal EGR device. As a result, due to the thermal capacity owned by the exhaust gas (inert gas) having flown into the cylinder and due to a decrease in the oxygen density in intake air, the maximum combustion temperature of the mixture in the cylinder is lowered, and accordingly, the emission of NOx can be reduced.

Further, in the engine operation range from a middle load to a high load, the controller closes the EGR valve in accordance with detection outputs received from the speed sensor and the load sensor. Exhaust gas from the exhaust passage flows into the cylinder, direct from the exhaust port by means of the internal EGR device, whereas exhaust gas in the exhaust passage is not recirculated into the cylinder through the EGR valve. As a result, due to the thermal capacity owned by the exhaust gas (inert gas) having flown into the cylinder and due to a decrease in the oxygen density in intake air, the maximum combustion temperature of the mixture in the cylinder is lowered, and therefore, the emission of NOx can be reduced. Simultaneously, the amount of intake air flowing into the cylinder is extremely larger than the amount of EGR gas flowing into the cylinder in the engine operation range from a middle load to a high load, insufficiency of air in the cylinder can be eliminated, and accordingly, the emission of black smoke from the engine can be reduced.

According to a second aspect of the present invention, in addition to the arrangement of the first aspect of the present invention, the internal EGR device includes an EGR protrusion for opening the exhaust valve of the cylinder during intake stroke, formed at a position on the outer peripheral surface of an exhaust cam.

In the exhaust gas recirculation system according to the second aspect of the present invention, the exhaust valves are opened during intake stroke of the cylinder, irrespective of the operating condition of the engine by means of the EGR protrusion formed on the exhaust cam. Accordingly, exhaust gas is mingled into intake air in the cylinder, and therefore, due to the thermal capacity owned by the exhaust gas (inert gas) having flown into the cylinder and due to a decrease in the oxygen density in intake air, the maximum combustion temperature of the mixture in the cylinder is lowered, and therefore, the emission of NOx can be reduced.

According to a third aspect of the present invention, in addition to the arrangement of the first aspect of the present invention, the internal EGR device includes a master piston which is actuated by an intake rocker arm for opening the intake valves during intake stroke of the cylinder, a slave piston connected to the master piston through the intermediary of an oil passage, for opening the exhaust valve of the cylinder by means of hydraulic pressure which is produced through the operation of the master piston, and a hydraulic change-over means for changing over the condition of the hydraulic pressure between a hold condition and an opened condition in the oil passage.

In the exhaust gas recirculation system according to the third aspect of the present invention, the hydraulic change-over means holds hydraulic pressure in the oil passage in an operation range from a middle load to a high load, the intake rocker arm pushes up the master piston so as to increase the hydraulic pressure in the oil passage, and accordingly, this hydraulic pressure pushes down the slave piston. As a result, the exhaust valve is opened, and accordingly, due to the thermal capacity owned by the exhaust gas (inert gas) having flown into the cylinder and due to a decrease in the oxygen density in intake air, the maximum combustion temperature of the mixture in the cylinder is lowered, and therefore, the emission of NOx can be reduced.

### BRIEF DESCRIPTION OF THE DRAWINGS

These and other features and advantages of the present invention will become apparent from the following detailed description of preferred embodiments of the invention with reference to the accompanying drawings in which:

FIG. 1 is a view illustrating an arrangement of an external EGR device in an exhaust gas recirculation system in a first embodiment of the present invention;

FIG. 2 is a sectional view illustrating an engine including an internal EGR device in the first embodiment of the present invention;

FIG. 3 is a chart showing opening and closing timing of intake and exhaust valves of the engine;

FIG. 4 is a view showing operation ranges of the external EGR device and the internal EGR device in accordance with operating condition of the engine;

FIG. 5 is a sectional view illustrating a second embodiment of the present invention, corresponding to FIG. 2;

FIG. 6 is a view showing operation ranges of the external EGR device and the internal EGR device in accordance with the operating condition of the engine in the second embodiment of the present invention.

### DETAILED DESCRIPTION OF PREFERRED EMBODIMENTS

Explanation will be hereinbelow made of a first embodiment of the present invention with reference to the drawings.

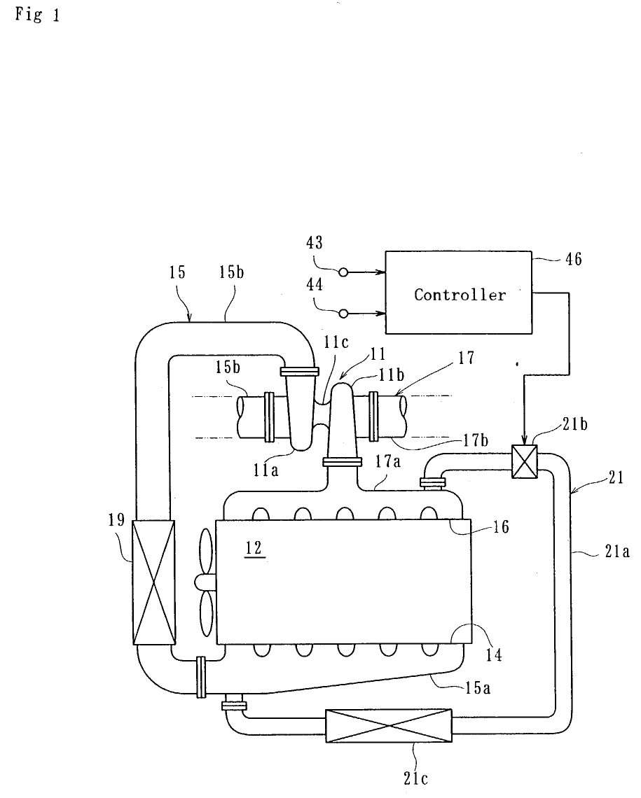

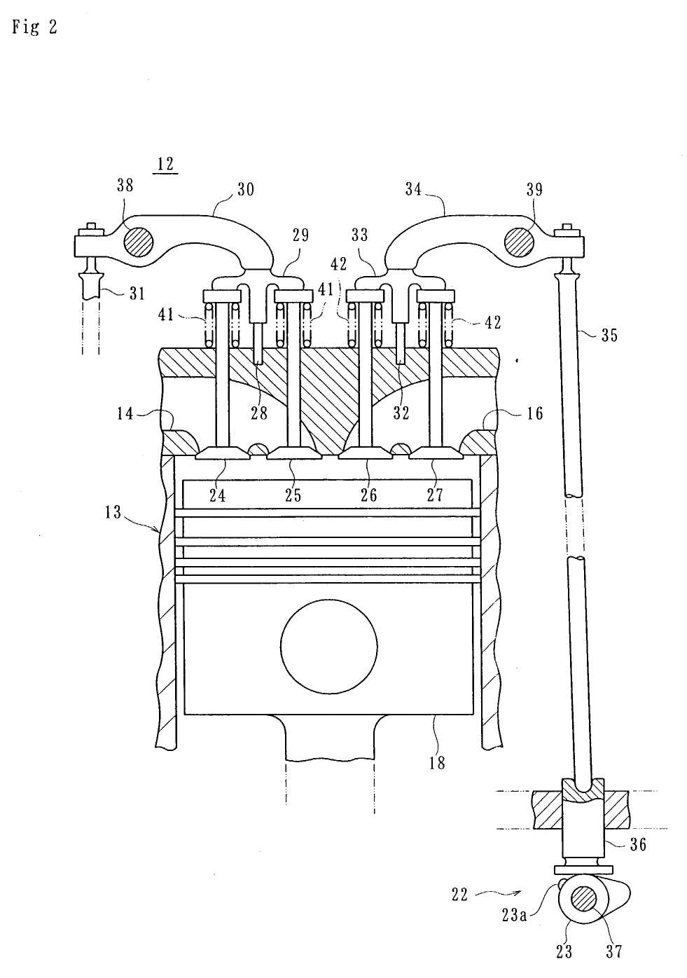

As shown in FIGS. 1 and 2, a vehicle is installed therein with a Diesel engine 12 incorporating a turbo-supercharger 11. A cylinder 13 of this engine 12 is connected at its intake port 13 with an intake pipe 15b through an intake passage 15 or an intake manifold 15a, and is connected at its exhaust port 16 with an exhaust pipe 17b through an exhaust passage 17 or an exhaust manifold 17a. A piston 18 is provided in the cylinder 13 so as to be vertically movable. The turbo-supercharger 11 is composed of a compressor housing 11a provided in the intake pipe 15b and rotatably accommodated therein with a compressor impeller (which is not shown), and a turbine housing 11b provided in the exhaust pipe 17b and rotatably accommodated therein with a turbine impeller (which is not shown). The turbine housing 11b and the compressor housing 11a are connected with each other through the intermediary of a connection part 11c which rotatably holds the center of a shaft (which is not shown), and the turbine impeller and the compressor impeller are fitted to the front and rear ends of this shaft. It is noted that reference numeral 19 in FIG. 1 denotes an aftercooler provided in the intake pipe 15b between the compressor housing 11a and the intake manifold 15a, for cooling intake air.

Further, the engine 12 is provided therein with an external EGR device 21 (refer to FIG. 1) for recirculating a part of exhaust gas in the exhaust manifold 17a into the intake manifold 15a through an EGR pipe 21a, and an internal EGR valve device 22 (refer to FIG. 2) for opening exhaust valves 26, 27 so as to introduce a part of exhaust gas into the cylinder 13 during intake stroke of the cylinder 13. The external EGR device 21, as shown in detail in FIG. 1, comprises the above-mentioned EGR pipe 21a connected at one end thereof to the exhaust manifold 17a so as to bypass the engine 12, and connected at the other end thereof to the intake manifold 15a, an EGR valve 21b provided in the EGR pipe 21a, for regulating the flow rate of exhaust gas recirculated into the intake manifold 15a from the exhaust manifold 17a through the EGR pipe 21a. The EGR valve 21b is a motor driven valve in which a valves element is driven by a motor so as to adjust the opening degree of the valve body. It is noted that an air driven type valve or the like may be used as the EGR valve 21b, instead of the motor driven valve. An EGR cooler 21c is provided in the EGR pipe 21a, for cooling exhaust gas (EGR gas) recircuilated into the intake manifold 15a.

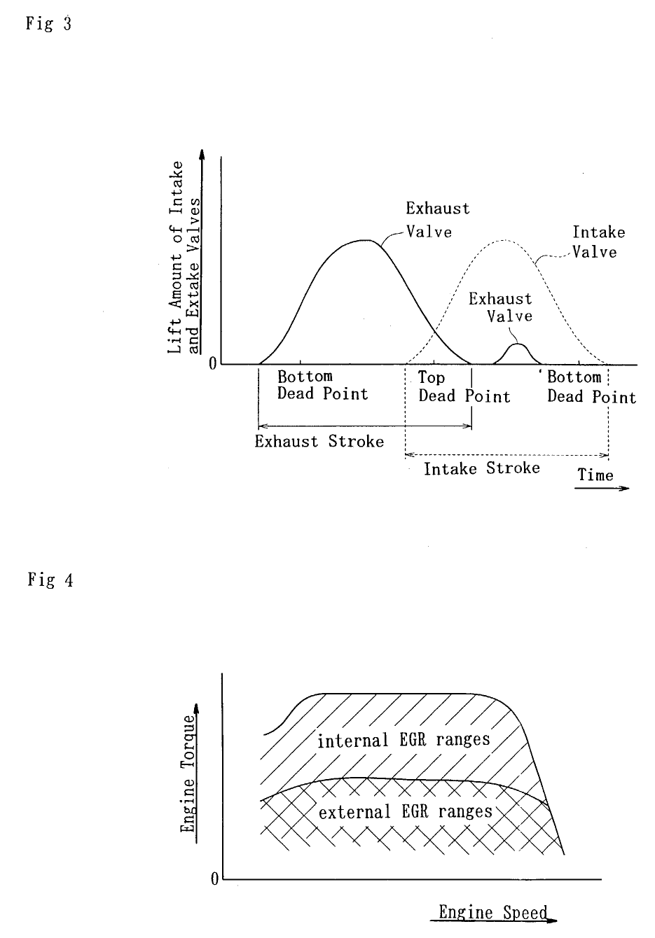

As shown in detail in FIG. 2, the internal EGR device 22 includes an EGR protrusion 23a formed at the outer peripheral surface of an exhaust cam 23 for opening exhaust valves 26, 27 of the cylinder 13. The cylinder 13 is provided with a pair of intake valves 24, 25, and a pair of exhaust valves 26, 27. The intake valves 24, 25 are adapted to be opened and closed by an intake push rod 31 through the intermediary of an intake bridge 29 fitted, vertically movable, in an intake guide shaft 28, and an intake rocker arm 30. The exhaust valves 26, 27 are adapted to be opened and closed by an exhaust push rod 35 through the intermediary of an exhaust bridge 33 fitted, vertically movable, in an exhaust guide shaft 32, and an exhaust rocker arm 34. An exhaust tappet 36 abuts against the exhaust push rod 35, and the above-mentioned exhaust cam 23 formed on an exhaust cam shaft 37 driven by a crank shaft (which is not shown) abuts at its outer peripheral surface against the lower end of the exhaust tappet 36. The above-mentioned EGR protrusion 23a is formed on the outer peripheral surface of the exhaust cam 23 at a position where the exhaust valves 26, 27 are opened during intake stroke of the cylinder 13 (refer to FIGS. 2 and 3). Further, the intake rocker arm 30 and the exhaust rocker arm 34 are rotatably supported to an intake arm rocker shaft 38 and an exhaust arm rocker shaft 39, respectively. An intake spring (compression spring) 41 and an exhaust spring (compression spring) 42 (refer to FIG. 2) are adapted to push up the intake valves 24, 25 and the exhaust valves 26, 27 so as to close the intake port 14 and the exhaust port 16, respectively.

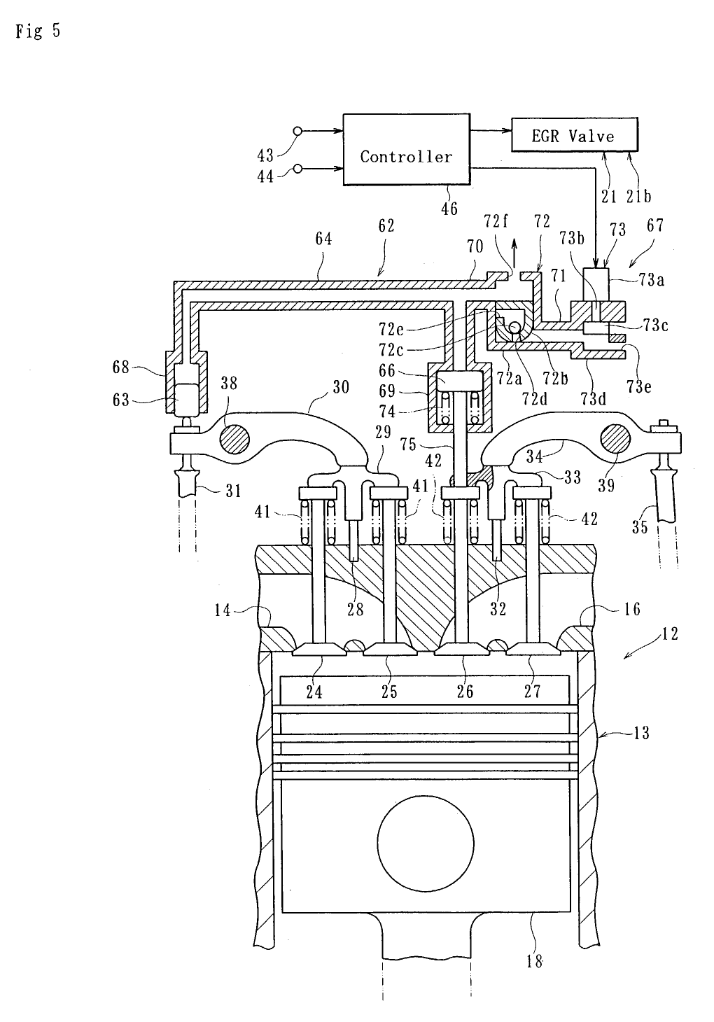

Further, the engine 12 is provided with a speed sensor 43 for detecting a rotational speed of the crankshaft, and a load sensor 44 for detecting a degree of depression of an accelerator pedal, that is, detecting a load of the engine 12 (refer to FIG. 1). The outputs of the speed sensor 43 and the load sensor 44 are connected to control inputs of a controller 46 incorporating a memory (which is not shown) which stores therein a map indicating a range where the EGR valve 21b is opened in accordance with a speed of the engine 12 and a load of the engine 12 (refer to FIG. 4).

Explanation will be made of the thus constructed exhaust gas recirculation system.

In an engine operation range from a low load to a middle load of the engine 12, the controller 46 receives detection outputs from the speed sensor 43 and the load sensor 44, and compares them with the map (refer to FIG. 4) stored in the memory so as to open the EGR valve 21b with a predetermined opening degree. At this time, since the flow rate of exhaust gas discharged from the cylinder 13 is low, and since the rotational speed of the turbine impeller of the turbo-supercharger 11 is low, the boost pressure of intake air charged by the turbo-supercharger 11 is low. Accordingly, exhaust gas flows from the exhaust manifold 17a into the cylinder 13 of the engine 12 through the EGR pipe 21a and the intake manifold 15a. Meanwhile, since the exhaust push rod 35 is pushed up by the EGR protrusion 23a formed on the exhaust cam through the intermediary of the exhaust tappet 36 during intake stroke of the cylinder 13, the exhaust rocker arm 34 depresses the exhaust valves 26, 37 through the intermediary of the exhaust bridge 33. Accordingly, the exhaust valves 25, 26, that is, the exhaust port 16, are opened so that exhaust gas in the exhaust manifold 17a flows into the cylinder 13. As a result, the maximum combustion temperature of a mixture in the cylinder 13 is lowered due to the thermal capacity owned by exhaust gas (inert gas) and due to a decrease in oxygen density in intake air, thereby it is possible to reduce the emission of NOx.

Further, in an engine operation range from a middle load to a high load of the engine 12, the controller 46 receives detection outputs from the speed sensor 43 and the load sensor 44, and compares them with the map stored in the memory so as to close the EGR valve 21b. In this engine operation range from a middle load to a high load of the engine 12, the flow rate of exhaust gas discharged from the cylinder 13 into the exhaust manifold 17a is high, and since the rotational speed of the turbine impeller of the turbo-supercharger 11 is high, the boost pressure of intake air charged by the turbo-supercharger 11 becomes high. Thus, no substantial difference is appreciated between the pressure of exhaust gas in the exhaust manifold 17a and the pressure of intake air in the intake manifold 15a, and accordingly, since no exhaust gas flows into the exhaust manifold 17a into the intake manifold 15a through the EGR pipe 21a even though the EGR valve 21b is opened, the EGR valve 21b is closed. Meanwhile, similar to the engine operation range from a low load to a middle load, the EGR protrusion 23a opens the exhaust valves 26, 27 during intake stroke of the cylinder, 13, and accordingly, exhaust gas flows into the cylinder 13 from the exhaust manifold 17a. As a result, the maximum combustion temperature of a mixture in the cylinder 13 is lowered due to the thermal capacity of exhaust gas (inert gas) having flown into the cylinder 13 and due to a decrease in oxygen density in intake air, thereby it is possible to reduce the emission of NOx. Simultaneously. The amount of intake air flowing into the cylinder 13 during the engine operation range from a middle load to a high load is extremely larger than that of EGR gas flowing into the cylinder 13, and accordingly, insufficiency of air in the cylinder 13 is eliminated, thereby it is possible to reduce the emission of black smoke from the engine 12. Accordingly, NOx in the exhaust gas can be reduced by recirculating the exhaust gas into the cylinder 13 over the entire engine operation range including not only the range from a low load to a high load of the engine 12 but also the range from a middle load to a high load thereof.

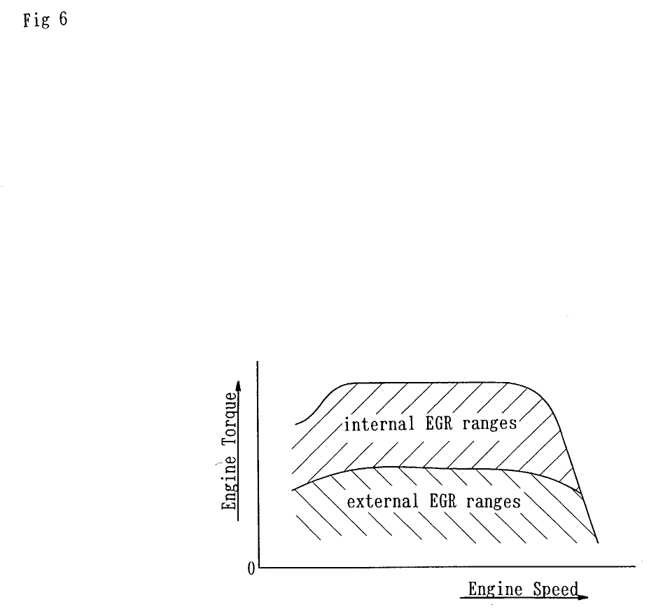

FIGS. 5 and 6 show a second embodiment of the present invention. Like reference numerals are used in FIG. 5 to denote parts like to those shown in FIG. 2.

In the arrangement of this second embodiment, the internal EGR device 62 is composed of a master piston 63 operated by an intake rocker arm 30 for opening the intake valves 24, 25 during intake stroke of the cylinder 13, a slave piston 66 connected to the master piston 63 through the intermediary of an oil passage 64, for opening the exhaust valve 26 of the cylinder 13 with the use of hydraulic pressure produced through the operation of the master piston 63, and a hydraulic change-over means 67 for changing over the condition of hydraulic pressure in the oil passage 64 between a hydraulic pressure holding condition and a hydraulic pressure releasing condition. The cylinder 13 is provided with a pair of intake valves 24, 25 and a pair of exhaust valves 26, 27, similar to the first embodiment. The intake valves 24, 25 are adapted to be opened and closed by the intake push rod 31 through the intermediary of an intake bridge 29 fitted, vertically movable, in the intake guide shaft 28, and the intake rocker arm 30, and the exhaust valves 26, 27 are adapted to be opened and closed by the exhaust push rod 35 through the intermediary of the exhaust bridge 33 fitted, vertically movable, in the exhaust guide shaft 32, and the exhaust rocker arm 34.

The master piston 63 is slidably accommodated in a master cylidner 68 arranged above the intake rocker arm 30, and the slave piston 66 is slidably accommodated in a slave cylinder 69 arranged above one of the pair of exhaust valves 26, 27. The master cylinder 68 and the slave cylinder 69 are connected and communicated with each other through the above-mentioned oil passage 64. Further, the hydraulic change-over means 67 is composed of an oil feed passage 71 connecting a branch passage 70 branching from the intermediate part of the oil passage 64 with a discharge port (which is not shown) of an oil pump, a solenoid valve 73 provided in the intermediate part of the oil feed passage 71, for communicating and isolating the branch passage 70 to and from the discharge port of the oil pump, and a control valve 72 provided in the connection part between the branch passage 70 and the solenoid valve 73.

The control valve 72 is composed of a movable casing 72b inserted, vertically movable, in a first large diameter passage 72a which is formed in the connection part between the oil feed passage 71 and the branch passage 70, being extended in the vertical direction, and a check ball 72c accommodated in the movable casing 72b. The lower part of the movable casing 72b is formed in a funnel shape, and is formed in its lower end with a through-hole 72d. The check ball 72c allows oil to flow into the movable casing 72b from the oil pump through the through hole 72d, but inhibit the oil from being discharged from the movable casing 72b through the through-hole 72d. Further, the movable casing 72b is formed at a side surface of the upper part thereof with a piercing hole 72e which is adapted to be communicated with the branch passage 70 when the movable casing 72b is pushed up. A first oil discharge port 72f is formed in the upper end of the first large diameter passage 72a, and is adapted to be communicated with the branch passage 70 when the movable casing 72b descents.

The solenoid valve 73 is composed of a solenoid casing 73a in which a solenoid (which is not shown) is accommodated, a plunger 73b extended from the solenoid casing 73a, and a valve element 73c provided at the front end of the plunger 73b and adapted to be moved up and down together with the plunger 73. The valve element 73c is inserted in a second large diameter passage 73d formed, being vertically extended, in the intermediate part of the oil feed passage 71, so as to be vertically movable, and the second large diameter passage 73d is formed therein with a second oil discharge port 73e for discharging oil in the oil supply passage 71 between the solenoid valve 73 and the control valve 72. When the solenoid valve 73 is energized, the valve element 73c descents so as to communicate the discharge port of the oil pump with the branch passage 70 while the oil feed passage 71 between the solenoid valve 73 and the control valve 72 is isolated from the second oil discharge port 73e. When the solenoid valve 73 is deenergized, the valve element 73 ascents so as to isolate the discharge port of the oil pump from the branch passage 70 while the oil feed passage 71 between the solenoid valve 73 and the control valve 72 is communicated with the second oil discharge port 73e.

Meanwhile, the slave piston 66 is pressed against the top surface of the slave cylinder 69 by a slave spring 74 (compression coil spring), and a slave rod 75 adapted to abut against the exhaust valve 26 is projected from the lower surface of the slave piston 66. Further, the control output of the controller 46 is connected to the EGR valve 21b in the external EGR device 21 and to the solenoid valve 73 in the internal EGR device 62. The controller 46 is provided therein with a memory (which is not shown) in which a map exhibiting a range where the EGR valve is opened and closed and the solenoid valve 73 is energized and deenergized in accordance with a speed of the engine 12 and a load of the engine 12, is stored (refer to FIG. 6). Those other than that mentioned above in this embodiment, are the same as that of the first embodiment.

Explanation will be made of the operation of the thus constructed exhaust gas recirculation system.

In the engine operation range from a low load to a middle load of the engine 12, the controller 46 receives detection outputs from the speed sensor 43 and the load sensor 44, and compares them with the map stored in the memory (refer to FIG. 6) so as to open the EGR valve 21b up to a predetermined opening degree while holds the solenoid valve 73 in its deenergized condition. At this time, since the flow rate of exhaust gas discharged from the cylinder 13 is low, the rotational speed of the turbine impeller of the turbo-supercharger 11 is low, and accordingly, exhaust gas flows from the exhaust manifold 17a into the cylinder 13 of the engine 12 through the EGR pipe and the intake manifold. Meanwhile, since the solenoid valve 73 is deenergized so that the movable casing 72b in the first large diameter passage 72a is held being lowered during intake stroke of the cylinder 13, although the intake rocker arm 30 pushes up the master piston 63, oil boosted up by the master cylinder 63 in the oil passage 64 is discharged from the first oil discharge port 72f. Accordingly, the slave piston 66 is not lowered so that the exhaust valve 26 is held in a condition such that the exhaust port 16 is closed. As a result, the maximum combustion temperature of a mixture in the cylinder 13 is lowered due to the thermal capacity owned by the exhaust gas (inert gas) which is recirculated into the cylinder 13 by the external EGR device 21, and due to a decrease in oxygen density in intake air, thereby it is possible to reduce the emission of NOx.

Further, in the engine operation of a middle load to a high load of the engine 12, the controller 46 receives detection outputs from the speed sensor 43 and the load sensor 44, and compares them with the map stored in the memory so as to close the EGR valve 21b while energize the solenoid valve 73. When the solenoid valve 73 is energized, the oil press-fed by the oil pump is fed into the oil passage 64 through the piercing hole 72e and the branch passage 70 after it pushes up the movable casing 72b which is then held in its pushed-up condition. At this time, even though the hydraulic pressure is applied to the slave piston 66 by the oil pump, the force for depressing the piston 18 in the engine 21, obtained by the hydraulic pressure is smaller than the resilient force of the slave spring 74, and accordingly, the slave piston 66 does not descend. When the piston 18 in the engine 12 initiates its descent upon initiation of intake stroke of the cylinder 13, the intake rocker arm 30 pushes up the master piston 63 so as to raise the hydraulic pressure in the oil passage 64, and accordingly, this hydraulic pressure depresses the slave piston 66. As a result, the slave rod 75 pushes down the exhaust valve 26 so as to open the exhaust port 16, and accordingly, exhaust gas flows into the cylinder 13. Thus, the maximum combustion temperature of a mixture in the cylinder 13 is lowered due to the thermal capacity owned by the exhaust gas (inert gas) having flow in the cylinder 13 and due to a decrease in oxygen density in intake air. Simultaneously, since the amount of intake air flowing into the cylinder is extremely larger than that of EGR gas flowing into the cylinder 13 in the engine operation range from a middle load to a high load, insufficiency of air in the cylinder 13 can be eliminated, and accordingly, the emission of black smoke can be reduced. Therefore, NOx in exhaust gas can be reduced by introducing exhaust gas into the cylinder 13 in the entire engine operation range including not only the operation range from a low load to a middle load but also the operation range from a middle load to a high load, without boosting up the pressure of EGR gas.

Although explanation has been made such that the present invention is applied to the Diesel engine in the above-mentioned first and second embodiments, it goes without saying that the present invention can also be applied to gasoline engines.

Further, in the above-mentioned first and second embodiments, although the EGR cooler is provided in the EGR pipe, the provision of this EGR cooler is not required if exhaust gas can be recirculated by a sufficient volume into the intake pipe without cooling exhaust gas (EGR gas) passing through the EGR pipe.

Further, in the above-mentioned first and second embodiments, although the downstream end of the EGR pipe is connected to the high pressure side of the intake passage, that is, it is connect to the intake manifold downstream of the compressor in the intake pipe, the downstream end of the EGR pipe may also be connected to the low pressure side of the intake pipe, that is, it can be connected to the intake pipe upstream of the compressor.

As mentioned above, according to the present invention, the turbine housing and the compressor housing of the turbo-supercharger are provided respectively in the exhaust passage and the intake passage of the engine, the EGR valve for adjusting the flow rate of exhaust gas recirculated into the intake passage is provided in the EGR passage in the external EGR device, which connects the exhaust passage to the intake passage, so as to introduce exhaust gas from the exhaust passage by opening the exhaust valve by means of the internal EGR valve while the controller controls the EGR valve or both EGR valve and the internal EGR device in accordance with detection outputs from the speed sensor and the load sensor. With this arrangement, exhaust gas is recirculated into the cylinder from the exhaust gas while exhaust gas is directly fed into the cylinder through the exhaust port in the engine operation range from a middle load to a high load of the engine. As a result, the maximum combustion temperature of a mixture in the cylinder is lowered due to the thermal capacity owned by the exhaust gas (inert gas) having flown in the cylinder and due to a decrease in oxygen density in intake air. Simultaneously, since the amount of intake air flowing into the cylinder is extremely larger than that of EGR gas flowing into the cylinder in the engine operation range from a middle load to a high load, insufficiency of air in the cylinder can be eliminated, and accordingly, the emission of black smoke can be reduced. Therefore, NOx in exhaust gas can be reduced by introducing exhaust gas into the cylinder in the entire engine operation range including not only the operation range from a low load to a middle load but also the operation range from a middle load to a high load, without boosting up the pressure of EGR gas.

Further, the EGR protrusion which serves as the internal EGR device and which is formed on the outer peripheral surface of the exhaust cam for opening the exhaust valve of the cylinder, is formed at the position, on the outer peripheral surface of the exhaust cam, at which the exhaust valve is opened during intake stroke of the cylinder, and accordingly, the exhaust valve can be opened by the EGR protrusion formed on the exhaust cam, irrespective of any operating condition of the engine. Thus, exhaust gas is mingled into intake air in the cylinder, and accordingly, the maximum combustion temperature of a mixture in the cylinder is lowered due to the thermal capacity owned by the exhaust gas (inert gas) having flow in the cylinder and due to a decrease in oxygen density in intake air, thereby it is possible to reduce the emission of NOx.

Alternatively, the internal EGR device is composed of the master piston operated by the intake rocker arm for opening the intake valve during intake stroke of the cylinder, the slave piston connected to the master piston through the intermediary of the oil passage, and adapted to open the exhaust valve of the cylinder with the use of hydraulic pressure boosted by the master piston, and the hydraulic change-over means for changing over the condition of the hydraulic pressure in the oil passage between the hydraulic pressure holding condition and the hydraulic pressure releasing condition. With this arrangement, the hydraulic pressure in the oil passage is held in the engine operation range from a low load to a high load of the engine, and accordingly, the intake locker arm pushes up the master piston during intake stroke of the cylinder so as to increase the hydraulic pressure in the oil passage. Thus, the thus increased hydraulic pressure presses down the slave piston, and accordingly, exhaust gas flows into the cylinder from the exhaust port. As a result, the maximum combustion temperature of a mixture in the cylinder is lowered due to the thermal capacity owned by the exhaust gas (inert gas) having flow in the cylinder and due to a decrease in oxygen density in intake air, thereby it is possible to reduce the emission of NOx.

What is claimed is:

1. An exhaust gas recirculation system for an engine incorporating a turbo-supercharger, comprising:
an intake passage connected to an intake port of an engine, for feeding air into a cylinder of the engine through a compressor housing of said turbo-supercharger;
an exhaust passage connected to an exhaust port of said cylinder, for discharging exhaust gas into the atmosphere from said cylinder through a turbine housing of said turbo-supercharger;
an external EGR device including an EGR passage connected at one end thereof to said exhaust passage and connected at the other end thereof to said intake passage, and an EGR valve provided in said EGR passage and adapted to adjust the flow rate of exhaust gas recirculated from said exhaust passage into said intake passage through said EGR passage;
an internal EGR device for opening an exhaust valve provided at the exhaust port, so as to introduce exhaust gas from said exhaust passage into said cylinder during intake stroke of said cylinder;
a speed sensor for detecting a speed of said engine;
a load sensor for detecting a load of said engine; and
a controller for controlling said EGR valve or both said EGR valve and said internal EGR device in accordance with detection outputs from said speed sensor and said load sensor.

2. The exhaust gas recirculation system of claim 1 wherein said internal EGR device includes an EGR protrusion for opening said exhaust valve of said cylinder during intake stroke thereof, formed at a position on the outer peripheral surface of an exhaust cam.

3. The exhaust gas recirculation system of claim 1 wherein said internal EGR device is composed of a master piston operated by an intake rocker arm adapted to open an intake valve during intake stroke of said cylinder, a slave piston connected to said master piston through the intermediary of an oil passage and adapted to open the exhaust valve of said cylinder with the use of hydraulic pressure produced through operation of said master piston, and a hydraulic change-over means for changing over the condition of hydraulic pressure in the oil passage between a hydraulic pressure holding condition and a hydraulic pressure releasing condition.
